(19) United States
(12) Patent Application Publication
(10) Pub. No.: US 2008/0048959 A1
(43) Pub. Date: Feb. 28, 2008

(54) Display device having a support structure

(75) Inventor: Li-Tien Tseng, Pa Te City (TW)

Correspondence Address: LADAS & PARRY, 26 WEST 61ST STREET, NEW YORK, NY, 10023, US

(73) Assignee: BENQ CORPORATION

(21) Appl. No.: 11/894,109

(22) Filed: Aug. 20, 2007

(30) Foreign Application Priority Data
Aug. 22, 2006 (TW) 95130887

(51) Int. Cl. A47F 7/00; G09G 3/36

(52) U.S. Cl. 345/87; 211/26

(57) ABSTRACT

A support structure includes a base and a support unit. The base has a restricting member for restricting movement of a lower portion of the display device with respect to the base. The support unit includes a pivot unit and a support plate. The pivot unit is disposed on the base at a location rearward from the restricting member. The support plate has a lower part pivoted to the pivot unit and an upper part abutting against the display device so as to dispose the display device at a predetermined angle with respect to the base.

### FIELD OF THE INVENTION

The present invention relates to a support structure, and more particularly to support structure for use in a display device.

### BACKGROUND OF THE INVENTION

Due to rapid development in the electronic technology, an LCD device of today is lightweight, thin thickness, small volume and consumes low power when compared to the conventional CRT type TV set. For a desktop computer (personal computer), an LCD device becomes an indispensable part since it serves as a display panel.

Referring to FIG. 1, a conventional display device is shown to include a display panel 11 (usually an LCD) and a support structure 10. The support structure 10 includes a base 102 and a support stand 104 extending upwardly from the base 102. The upper portion of the support stand 104 is formed with a recess 1042 for receiving a fastener member 106. The fastener member 106 includes a positioning seat 1064 fixed at the middle of the recess 1042 and two torsion springs 1063 mounted at two opposite sides of the seat 1064. Moreover, the display panel 11 has a mounting plate 112 at a rear side thereof, and a pair of lugs 113 projecting rearwardly from the mounting plate 112 for engaging the torsion springs 1063 in such a manner that the display panel 11 can be disposed at a desired angle by virtue of torsion force provided by the torsion springs 1063. Two protection covers 114 are coupled respectively to the lugs 113 in order to conceal the torsion spring 1063 therebetween.

Some disadvantages encountered during use of the aforementioned support structure 10 are as follows:

(1) After assembly of the display panel 11 on the support stand 104, the majority of the weight of the display panel is concentrated on the base 102. Due to the length limit, the reliable of the support stand 104 for supporting the display panel 11 should be taken into account for serious consideration.

(2) The base 102 has a relatively large dimension for holding the support stand 104, which, in turn can support the display panel 11 stably thereon. The support structure 10 is mounted on the display panel and the whole assembly thereof is put within a packing box for transport. After assembly, since the display device is generally T-shaped, a relatively large packing box is required for transport. The larger the packing box, the more the charge becomes for transporting the display device.

(3) In order to reduce the dimension of the packing box, the components forming the display device can be disassembled. However, thus doing inconvenient the sale agent, for the customer may usually request the sale agent to re-assemble the display device upon delivery at the destination.

Therefore, the main object of the present invention is to provide a support structure for use in a display device. The support structure includes detachable parts that can be assembled easily when required.

### SUMMARY OF THE INVENTION

Therefore, it is the object of the present invention 5 to provide a rotatable mechanism for use in a desktop computer. The rotatable mechanism includes a holding seat, a holding frame and a limiting stem that can be rotated together with the holding frame against torsion force of a spring unit to a desired angle with respect to the holding seat.

According to one aspect of the present invention, a support structure is provided for a display device. The support structure includes a base and a support unit. The base has a restricting member for restricting movement of a lower portion of the display device with respect to the base. The support unit includes a pivot unit and a support plate. The pivot unit is disposed on the base and spaced apart from the restricting member. The support plate has a lower part pivoted to the pivot unit and an upper part abutting against the display device at a position above the lower portion thereof so as to dispose the display device at a predetermined angle with respect to the base. Variation in the predetermined angle can be achieved by assistance of the support unit and the restricting member.

In a second aspect of the present invention, a display device is provided to include a display panel, a casing, and a support structure. The casing holds the display panel at a front side thereof, and has a lower portion and two pivots extending outwardly from two opposite ends of the lower portion. The support structure includes a base for pivotally receiving the pivots of the casing, a support unit and a restricting member. The support unit includes a pivot unit and a support plate. The pivot unit is disposed on the base at a location rearward from the casing. The support plate has a lower part pivoted to the pivot unit and an upper part abutting against the casing other than the lower portion thereof so as to dispose the casing at a predetermined angle with respect to the base. The restricting member is formed on the base frontward of the support unit, wherein, variation in the predetermined angle can be achieved by virtue of abutting the upper part of the support plate against different positions of the casing.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective rear view of a conventional display device;

FIG. 2A is a perspective front view of a display device of the present invention;

FIG. 2B is a perspective rear view of a display device of the present invention;

FIG. 3A is a partially exploded and perspective view of a support structure employed in the display device of the present invention in a used state;

FIG. 3B is an enlarged view of an encircled portion of the support structure shown in FIG. 3A;

FIG. 4A is a partially exploded and perspective view of a support structure employed in the display device of the present invention in a non-used state;

FIG. 4B is an enlarged view of an encircled portion of the support structure shown in FIG. 4A in the used state;

FIG. 5 is a fragmentary sectional view of the display device of the present invention taken along line a-a′ in FIG. 2A;

FIG. 6 is a fragmentary enlarged view of the display device of the present invention shown in FIG. 2A; and

FIGS. 7A to 7D respectively illustrate how the display panel of the display device of the present invention is retained at different desired angles by the support structure shown in FIGS. 3A and 3B.

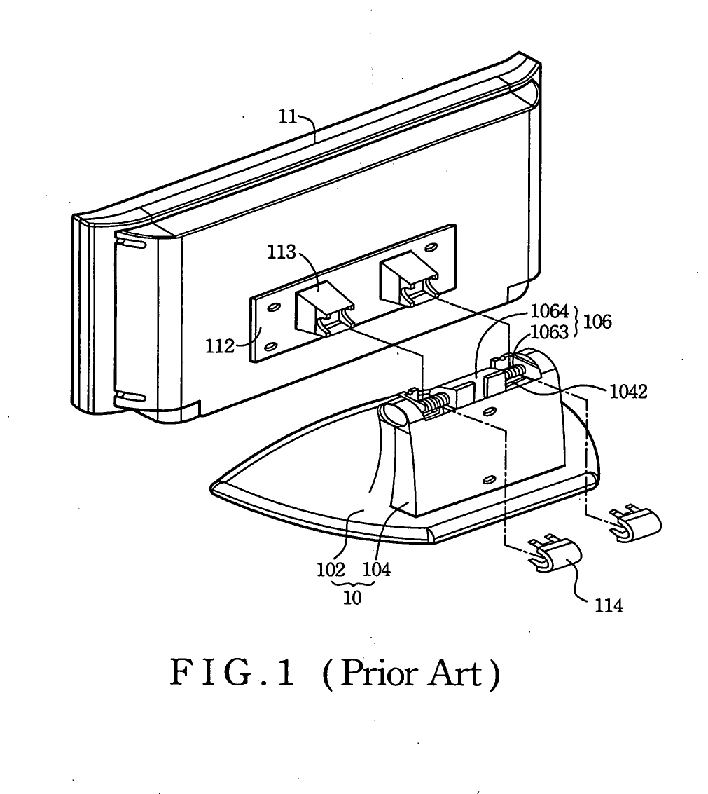

### DETAILED DESCRIPTIONS OF THE PREFERRED EMBODIMENTS

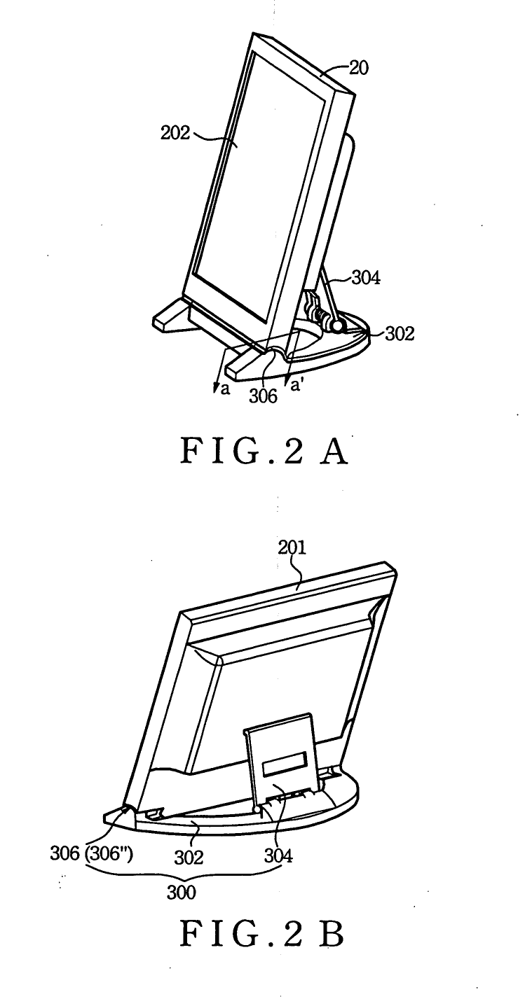

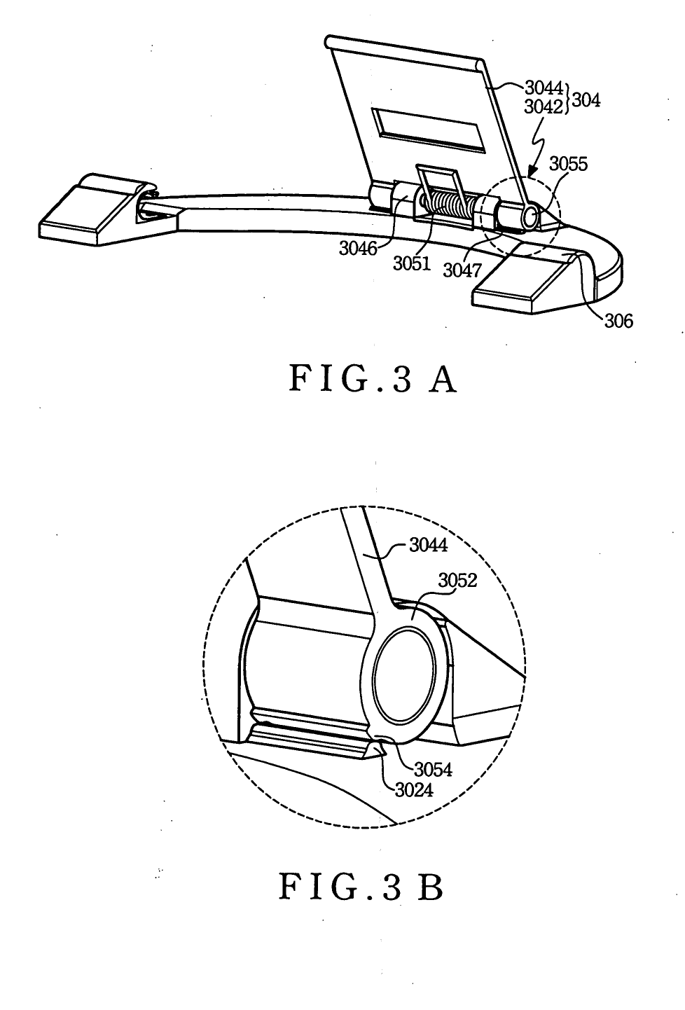

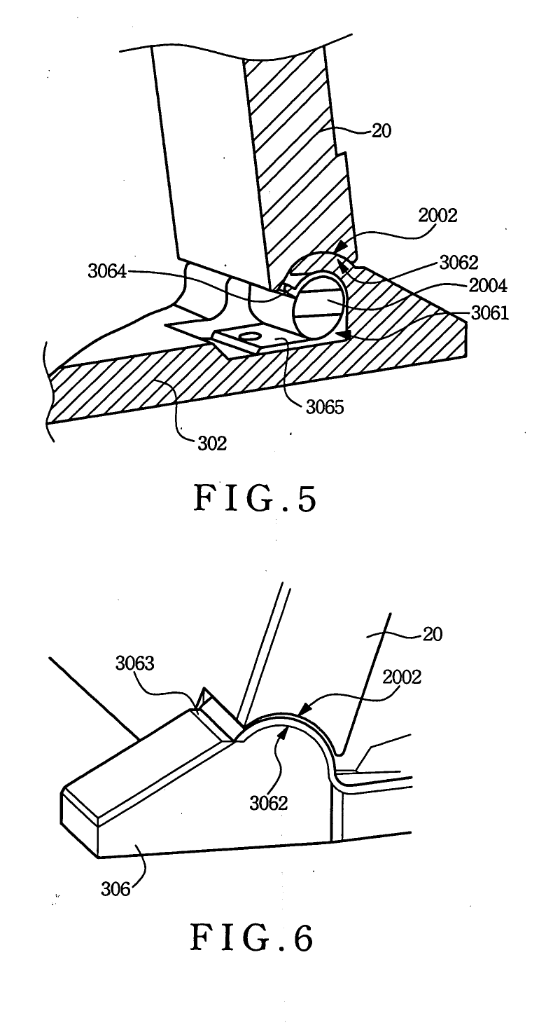

FIGS. 2A and 2B respectively show perspective front and rear views of a display device 20 of the present invention. The display device 20 accordingly includes a display panel 202, a casing 201 and a support structure 300. The display panel 202 is mounted at a front side of the casing 201. The casing 201 has a lower portion and two pivots 2004 (see FIG. 5) extending outwardly from two opposite ends of the lower portion. The support structure 300 is connected to a rear side of the casing 201, and includes a base 302 and a support unit 304. The base 302 has a restricting member 306 for restricting movement of the lower portion of the casing 201 with respect to the base 302. As illustrated, the restricting member 306 includes spaced apart left and right restricting blocks 306″ projecting upwardly form the base 302. The support unit 304 includes a pivot unit 3042 (see FIG. 3A) disposed on the base 302 at a location rearward from the restricting member 306, and a support plate 3044. The support plate 3044 has a lower part pivoted to the pivot unit 3042 and an upper part abutting against an upper portion of the casing 201 so as to dispose the casing 201 at a predetermined angle with respect to the base 302. Note that variation in the predetermined angle can be achieved by virtue of abutting the upper part of the support plate 3044 against different positions of the upper portion of the casing 201, a detailed description of which will be explained in the following paragraphs.

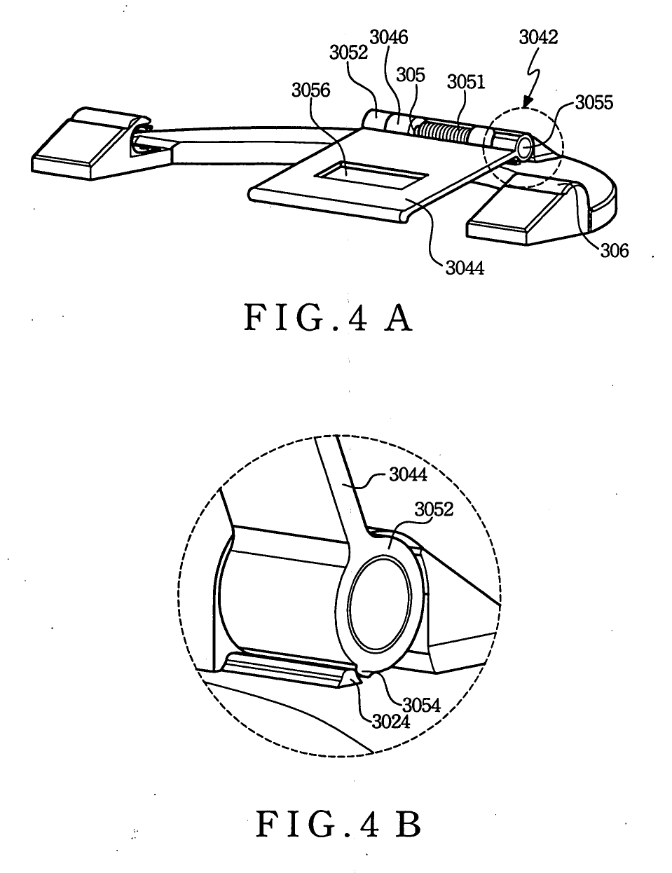

FIG. 3A is a partially exploded and perspective view of a support structure employed in the display device of the present invention in a used state. FIG. 3B is an enlarged view of an encircled portion of the support structure shown in FIG. 3A. FIG. 4A is a partially exploded and perspective view of the support structure employed in the display device of the present invention in a non-used state. FIG. 4B is an enlarged view of an encircled portion of the support structure shown in FIG. 4A in the used state. The pivot unit 3042 includes two pivot seats 3046, which are formed on the base 302 and which are formed with pivot hole 3047 respectively.

The lower part of the support plate 3044 is formed with two tubular sleeves 3052 respectively disposed adjacent to and in alignment with the pivot holes 3047 in the pivot seats 3046. The tubular sleeves 3052 define a gap 305 therebetween. The pivot unit 3042 further includes a torsion spring 3051 disposed between the pivot seats 3046 and a pivot shaft 3055 inserted through the pivot holes 3047 in the pivot seats 3046, the tubular sleeves 3052 of the support plate 3044 and the torsion spring 3051 to prevent disengagement of the support plate 3044 from the base 302.

Referring to FIGS. 3 and 4, each of the tubular sleeves 3052 of the support plate 3044 is formed with a protrusion 3054 on an external surface thereof. The base 302 further has a projection 3024 that is formed adjacent to a respective one of the protrusions 3024 and that is adapted to engage with the protrusion 3054 of the tubular sleeve 3052 upon rotation of the support plate 3044 relative to the base 302 about the pivot shaft 3055, thereby disposing the casing 201 at the predetermined angle with respect to the base 302. Note that engagement between the protrusion 3054 and the projection 3024 at different contact locations enables the support plate 3044 at different inclined angles with respect to the base 302, which, in turn, results in variation of the predetermined angles of the casing 201 with respect to the base 302. Moreover, the support plate 3044 further has a cable hole 3056 (see FIG. 4A) formed between the lower and upper parts thereof for extension of a connecting cable (not shown).

FIG. 5 is a fragmentary sectional view of the display device 20 of the present invention taken along line a-a′ in FIG. 2A. Each of the restricting blocks 306″ defines a recesses 3061 accessible from a rearward direction thereof and securely and respectively receiving a C-shaped hooks 3064. The pivots 2004 of the lower portion of the casing 201 extend respectively into the C-shaped hooks 3064, thereby preventing untimely disengagement of the casing 201 from the base 302 when the casing 201 is moved upward and downward and is rotated with respect to the base 302.

In addition, the lower portion of the casing 201 further includes two concave faces 2002 (see FIG. 5) respectively located at an elevation above the pivots 2004. Each of the C-shaped hooks 3064 has a horizontal part 3065 fixed to a bottom wall of a respective one of the recesses 3061 and a curved part extending integrally from the horizontal part 3065 so as to be located above a respective one of the pivots 2004 of the casing 201. Each of the recesses 3061 is defined by a recess-confining wall having a curved wall section 3062 overlapping the curved part of the C-shaped hooks 3064 (see FIG. 5) so as to support a respective one of the concave faces 2002 of the casing 201. In this embodiment, the pivots 2004 can be integrally formed with the lower portion of the casing 201. Alternately, the pivots 2004 are detachably inserted into two opposite ends of the lower portion of the casing 201. Regardless of the mounting methods, when it is desired to removed the casing 201 from the base 302, the casing 201 can be rotated in the rearward direction with respect to the restricting blocks 306″ to a position, in which, the pivots 2004 of the casing 201 are aligned with the entrances of the recesses 3061. At this time, pulling the casing 201 in the rearward direction can result in removal of the pivots 2004 from the C-shaped hooks 3064.

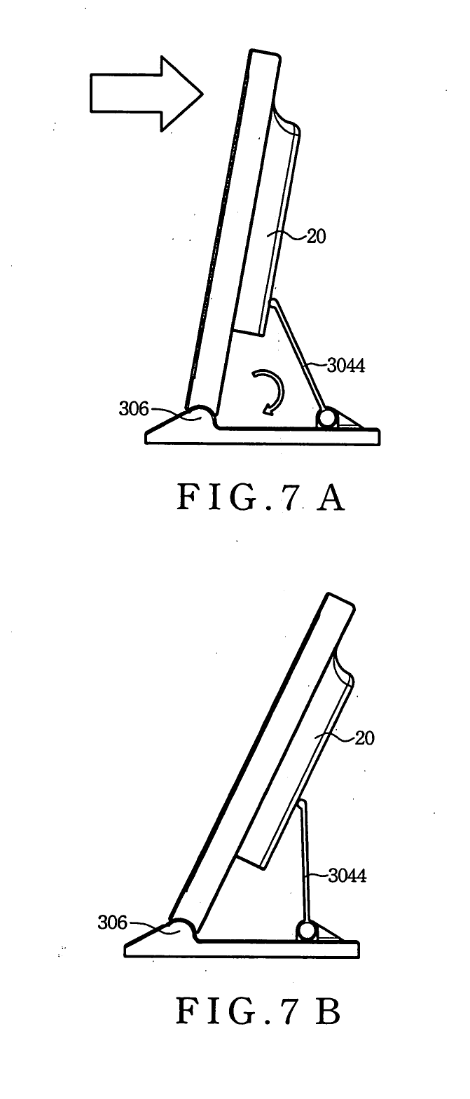

Referring to FIG. 6, the restricting member 306 5 further includes two stop members 3063 in the form of flat faces and respectively disposed frontward of the recesses 3061 for stopping front ends of the concave faces 2002 of the casing 201, thereby retaining the casing 201 at an inclined angle with respect to the base 302 in case the casing 201 is folded in a frontward direction. The arrangement of the stop members 3063 can prevent damage done onto the display panel 202 if the casing 201 accidentally falls in the forward direction during handling of the casing 201.

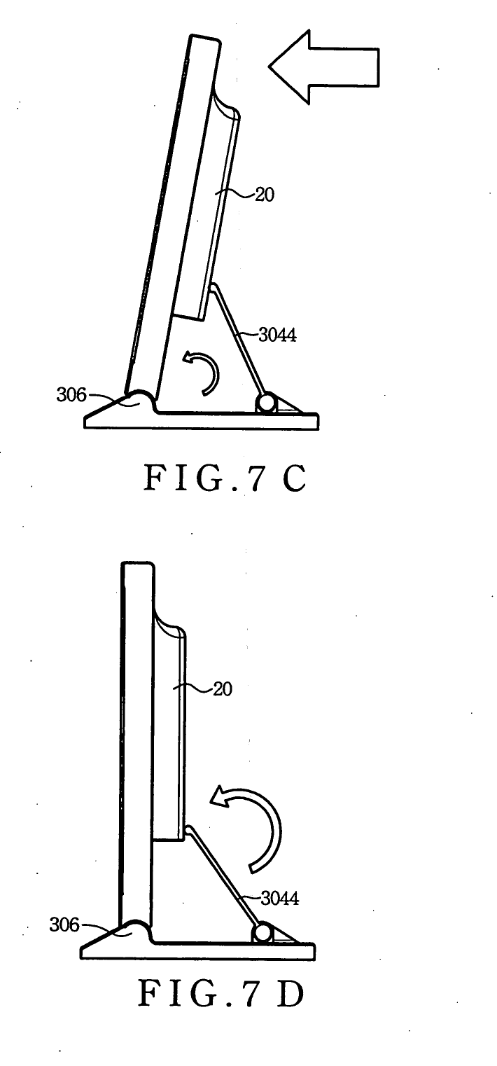

FIGS. 7A to 7D respectively illustrate how the display panel 202 of the display device 20 of the present invention is retained at different desired angles by the support structure 300 shown in FIGS. 3A and 3B. Note that after assembly, the torsion spring 3051 is sandwich between the base 302 and the support plate 3044 and biasing the support plate 3044 in such a manner to provide a torque force for pushing the support plate 3044 to press against the base 302 in a normal condition, i.e, in the storage condition (see FIG. 4A). The support plate 3044 is rotatable away from the base 302 against twisting force of the torsion spring 3051 to press the upper part of the support plate 3044 against the casing 201 so as to dispose the casing 201 at the predetermined angle with respect to the base 302. Variation of the predetermined angle can be achieved by simply pushing the casing 201 against the biasing action of the support plate 3044. The torsion spring 3051, the protrusions 3054 and the projections 3024 of the tubular sleeves 3052 and the base 302 cooperatively supply the biasing action of the support plate 3044.

The advantages provided by the support structure employed in the display device 20 of the present invention are as follows:

(1) The lower part of the support plate 3044 can be pivoted to the pivot seat 3042 by means of the pivot shaft 3055. The support plate 3044 is tight abutment with the base 302 due to twisting force provided by the torsion spring 3051. The casing 201 is not mounted on the base 302, but is rather detached from the base 302. Under this condition, the volume of the box for packing the display device 20 can be minimized.

(2) After delivery of the display device 20 to its destination, after tilting the casing 201 relative the base 302 so as to align the pivots 2004 with the entrances of the C-shaped hooks 3064, the pivots 2004 of the casing 201 can be inserted into the C-shaped hooks 3064 of the base 302, thereby completing the assembly of the casing 201(hence the display panel 202) relative to the base 302.

(3) Since the cost for transporting small box is cheaper, the manufacturing expense as a whole can be reduced.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A support structure for a display device, comprising:
a base having a restricting member for restricting movement of a lower portion of the display device with respect to said base; and
a support unit including
a pivot unit disposed on said base and spaced apart from said restricting member, and
a support plate having a lower part pivoted to said pivot unit and an upper part abutting against the display device at a position above said lower portion thereof so as to dispose the display device at a predetermined angle with respect to said base;
wherein, variation in said predetermined angle can be achieved by assistance of said support unit and said restricting member.

2. The support structure according to claim 1, wherein said pivot unit is located rearward of said restricting member.

3. The support structure according to claim 1, wherein said pivot unit includes a pair of pivot seats, which are formed on said base and which are formed with pivot hole respectively.

4. The support structure according to claim 3, wherein said lower part of said support plate is formed with two tubular sleeves respectively disposed adjacent to said pivot seats in alignment with said pivot holes in said pivot seats and defining a gap therebetween.

5. The support structure according to claim 4, wherein said pivot unit further includes a torsion spring disposed between said pivot seats and a pivot shaft inserted through said pivot holes in said pivot seats, said tubular sleeves of said support plate and said torsion spring to prevent disengagement of said support plate from said base.

6. The support structure according to claim 4, wherein each of said tubular sleeves of said support plate is formed with a protrusion on an external surface thereof, said base further having a projection formed adjacent to a respective one of said protrusions and adapted to engage with said protrusion of said tubular sleeve upon rotation of said support plate relative to said base about said pivot shaft.

7. The support structure according to claim 4, wherein said restricting member includes two generally C-shaped hooks and two spaced apart restricting blocks defining two recesses accessible from a rearward direction thereof and securely and respectively receiving said C-shaped hooks, the lower portion of the display device being coupled pivotally respectively to said C-shaped hooks, thereby preventing untimely disengagement of the display device from said base.

8. The support structure according to claim 7, wherein each of said C-shaped hooks has a horizontal part fixed to a bottom wall of a respective one of said recesses and a curved part extending integrally from said horizontal part and disposed above a respective one of said pivots.

9. The support structure according to claim 8, wherein the display device further includes two concave faces respectively located at an elevation above said pivots, each of said recesses being defined by a recess-confining wall having a curved wall section overlapping said curved part of said C-shaped hooks so as to support a respective one of the concave faces of the display device.

10. The support structure according claim 9, wherein said restricting member further includes two stop members respectively disposed frontward of said recesses for stopping front ends of the concave faces of the display device, thereby retaining the display device at an inclined angle with respect to said base in case the display device is folded in a frontward direction.

11. A display device comprising:
a display panel;
a casing holding said display panel, and having a lower portion and two pivots extending outwardly from two opposite ends of said lower portion; and
a support structure including
a base for pivotally receiving said pivots of said casing,
a support unit including a pivot unit disposed on said base and a support plate having a lower part pivoted to said pivot unit and an upper part abutting against said casing so as to dispose said casing at a predetermined angle with respect to said base, and
a restricting member formed on said base frontward of said support unit;
wherein, variation in said predetermined angle can be achieved by virtue of abutting said upper part of said support plate against different positions of said upper portion of said casing.

12. The display device according to claim 11, wherein said pivot unit includes a pair of pivot seats, which are formed on said base and which are formed with pivot hole respectively.

13. The display device according to claim 12, wherein said lower part of said support plate is formed with two tubular sleeves respectively disposed adjacent to and in alignment with said pivot holes in said pivot seats and defining a gap therebetween.

14. The display device according to claim 13, wherein said pivot unit further includes a torsion spring disposed between said pivot seats and a pivot shaft inserted through said pivot holes in said pivot seats, said tubular sleeves of said support plate and said torsion spring to prevent disengagement of said support plate from said base.

15. The display device according to claim 14, wherein each of said tubular sleeves of said support plate is formed with a protrusion on an external surface thereof, said base further having a projection formed adjacent to a respective one of said protrusions and adapted to engage with said protrusion of said tubular sleeve upon rotation of said support plate relative to said base about said pivot shaft.

16. The display device according to claim 11, wherein said support plate further has a cable hole formed between said lower and upper parts thereof for extension of a connecting cable.

17. The display device according to claim 11, wherein said restricting member further includes two generally C-shaped hooks and two spaced apart restricting blocks formed on said base to define two recesses accessible from a rearward direction thereof and securely and respectively receiving said C-shaped hooks, said pivots of said casing extending respectively into said C-shaped hooks, thereby preventing untimely disengagement of said casing from said base.

18. The display device according to claim 17, wherein each of said C-shaped hooks has a horizontal part fixed to a bottom wall of a respective one of said recesses and a curved part extending integrally from said horizontal part and disposed above a respective one of said pivots.

19. The display device according to claim 17, wherein said casing further includes two concave faces respectively located at an elevation above said pivots, each of said recesses being defined by a recess-confining wall having a curved wall section overlapping said curved part of said C-shaped hooks so as to support a respective one of the concave faces of said casing.

20. The display device according to claim 19, wherein said restricting member further includes two stop members respectively disposed frontward of said recesses for stopping front ends of said concave faces of said casing, thereby retaining said casing at an inclined angle with respect to said base in case said casing is folded in a frontward direction.
